(19) United States
(12) Patent Application Publication
(10) Pub. No.: US 2026/0220427 A1
(43) Pub. Date: Jul. 30, 2026

(54) DISTRIBUTED NEURAL NETWORK FOR AIRCRAFT

(71) Applicant: ADEIA SEMICONDUCTOR TECHNOLOGIES LLC, San Jose, CA (US)

(72) Inventors: Kuo An Chao, Burbank, CA (US); Seung Kang, San Diego, CA (US)

(21) Appl. No.: 19/037,667

(22) Filed: Jan. 27, 2025

(51) Int. Cl. G06N 3/045; B64D 45/00; G08G 5/26

(52) U.S. Cl. CPC G06N 3/045; B64D 45/00; G08G 5/26; B64D 2045/0085

(57) ABSTRACT

Disclosed is a distributed neural network for aircraft monitoring. The distributed neural network includes an edge-side neural network system and a cloud-side neural network system. The edge-side system is for implementation in an aircraft and uses an edge-side neural network model to process sensor data, classify it to detect early stage notification of one or more subsystems of the aircraft, provide an early stage notification, and transmit outputs to the cloud-side system. The cloud-side system is for implementation in a ground station and uses a cloud-side neural network model to analyze the edge-side output, determine the aircraft's state of health (including predictive failure points), and update the edge-side model's parameters for further input.

### TECHNICAL FIELD

This disclosure generally relates to artificial intelligence (AI)-driven systems for monitoring an aircraft, more particularly, to a distributed neural network for monitoring subsystems of the aircraft.

### BACKGROUND

An aircraft subsystems (e.g., including aircraft components) life cycle monitoring system is generally designed to oversee the performance of aircraft subsystems (e.g., including aircraft components) throughout their entire life cycle. This life cycle encompasses the initial design and manufacturing stages, extends through in-service operational use and scheduled maintenance, and concludes with component overhaul, retirement, or recycling. By integrating advanced sensor technologies, real-time data acquisition, predictive analytics, and maintenance optimization strategies, the aircraft subsystems (e.g., including aircraft components) life cycle monitoring system enhances safety, reduces downtime, and improves overall operational efficiency. Current trends in the aviation industry show a growing reliance on electrical and hardware systems to operate modern aircraft. This reliance has led to an increase in the number and complexity of these components, coupled with the dependence of pilots and operational teams on the accuracy of data generated by these systems. Since the reliability and efficiency of an aircraft are directly proportional to the operational accuracy of its components, there is a need for systems and methods capable of managing component life cycles and predicting failures at early stages. For example, the increasing complexity of avionics systems and their interdependence with other aircraft subsystems exacerbate the difficulty of isolating and predicting failure modes in real-time. Additionally, the increased volume of data generated by modern aircraft systems demands advanced processing capabilities to ensure timely and actionable insights. Without efficient life cycle monitoring and failure prediction systems, aircraft operators face risks such as unplanned downtime, reduced operational efficiency, and compromised safety. In response to these challenges, improved aircraft subsystems (e.g., including aircraft components) life cycle monitoring systems are needed to accommodate the growing complexity and criticality of electrical and hardware components. Therefore, improved aircraft subsystems (e.g., including aircraft components) life cycle monitoring systems are needed to meet these demands.

### SUMMARY

In one aspect, a distributed neural network for aircraft monitoring includes an edge-side neural network system for implementation in an aircraft, and a cloud-side neural network system for implementation in a ground station. The edge-side neural network system includes a local memory and a local processor. The edge-side neural network system further includes an edge-side neural network model to be stored on the local memory, and the local processor is communicatively coupled with the local memory and adapted to execute the edge- side network model. The edge-side network model is configured to receive as input sensor data in real time from a plurality of sensors installed on the aircraft for sensing operational parameters of one or more subsystems of the aircraft, classify the sensor data to determine whether one or more of the sensor satisfies a predetermined early stage notification criteria of the one or more subsystems, provide an early stage notification based on the classified sensor data, and provide the sensor data and the classified sensor data as an output to a cloud-side neural network system communicatively coupled with the edge-side neural network system. The cloud-side neural network system includes a cloud-side neural network model configured to receive the output of the edge-side neural network model, determine a state of health of the aircraft including states of health of the one or more subsystems, and output updated parameters for the edge-side neural network model as further input to be transmitted to the edge-side neural network system.

In another aspect, a method for aircraft monitoring includes receiving sensor data in real time from a plurality of sensors installed on an aircraft as an input to an edge-side neural network model stored in a local memory of an edge-side neural network system for implementation in an aircraft; generating an early stage notification of subsystems of the aircraft by executing the edge-side neural network model, using a local processor communicatively coupled with the local memory to classify the sensor data to determine whether one or more of the sensor data satisfies a predetermined early stage notification criteria of the one or more subsystems and determine the early stage notification based on the classified sensor data; providing the sensor data and the classified sensor data, as an output to a cloud- side neural network model included in a cloud-side neural network system for implementation in a ground station, where the cloud-side neural network system communicatively coupled with the edge-side neural network system; determining a state of health of the aircraft, including states of health of the one or more subsystems; determining parameters for the edge- side neural network model based on the state of health of the aircraft and the generated early stage notification; and updating parameters of the edge-side neural network model, by the edge-side neural network system, with the determined parameters transmitted from the cloud- side neural network system.

In another aspect a non-transitory computer readable medium stores instructions to be executed by one or more processors, causing the one or more processors to perform a method of receiving sensor data in real time from a plurality of sensors installed on an aircraft as an input to an edge-side neural network model stored in a local memory of an edge-side neural network system for implementation in an aircraft; generating an early stage notification by executing the edge-side neural network model, using a local processor communicatively coupled with the local memory to classify the sensor data to determine whether one or more of the sensor data satisfies a predetermined early stage notification criteria of the one or more subsystems, and determine the early stage notification based on the classified sensor data; providing the sensor data and the classified sensor data, as an output to a cloud-side neural network model included in a cloud-side neural network system for implementation in a ground station, the cloud-side neural network system communicatively coupled with the edge-side neural network system; receiving updated parameters for the edge- side neural network model from the cloud-side neural network system; and updating parameters of the edge-side neural network model, by the edge-side neural network system, with the updated parameters.

In another aspect, an aircraft includes an edge-side neural network system for implementation in an aircraft, and a cloud-side neural network system for implementation in a ground station. The edge-side neural network system includes a local memory and a local processor. The edge-side neural network system further includes an edge-side neural network model to be stored on the local memory, and the local processor is communicatively coupled with the local memory and adapted to execute the edge-side network model. The edge-side network model is configured to receive as input sensor data in real time from a plurality of sensors installed on the aircraft for sensing operational parameters of one or more subsystems of the aircraft, classify the sensor data to determine whether one or more of the sensor data satisfies a predetermined early stage notification criteria of the one or more subsystems, provide the early stage notification based on the classified sensor data, and provide the sensor data and the classified sensor data as an output to a cloud-side neural network system communicatively coupled with the edge-side neural network system. The cloud-side neural network system includes a cloud-side neural network model configured to receive the output of the edge-side neural network model, determine a state of health of the aircraft including states of health of the one or more subsystems, and output updated parameters for the edge- side neural network model as further input to be transmitted to the edge-side neural network system.

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. Moreover, those skilled in the art will understand that the drawings are not to scale. Wherever possible, like elements have been indicated by identical numbers. The detailed description of embodiments and the embodiments set forth in the drawings present various descriptions of specific embodiments of the invention. However, the invention can be embodied in a multitude of different ways. It will be understood that certain embodiments can include more elements than illustrated in a drawing and/or a subset of the elements illustrated in a drawing. Further, some embodiments can incorporate any suitable combination of features from two or more drawings. The present disclosure is not limited to specific methods and apparatus disclosed herein.

FIG. 1 illustrates an example environment of a ground station communicatively connected with multiple aircraft, according to an embodiment.

FIG. 2 illustrates an example of a hardware arrangement of a distributed neural network, according to an embodiment.

FIG. 3 illustrates an example structure of a neural network model, according to an embodiment.

FIG. 4 illustrates an example block diagram of a cloud-side neural network model, according to an embodiment.

FIG. 5A illustrates an example workflow, according to an embodiment.

FIG. 5B illustrates another example of workflow, according to an embodiment.

FIG. 5C illustrates another example of workflow, according to an embodiment.

### DETAILED DESCRIPTION

Although several embodiments, examples, and illustrations are disclosed below, it will be understood by those of ordinary skill in the art that the disclosure described herein extends beyond the specifically disclosed embodiments, examples, and illustrations and includes other uses of the disclosure and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of some specific embodiments of the disclosure. In addition, embodiments can comprise several novel features. No single feature is solely responsible for its desirable attributes or is essential to practicing the disclosure herein described.

The aircraft industry is experiencing a growing demand for processing large volumes of data to manage the life cycle of aircraft subsystems (e.g., including aircraft components), including electrical and hardware systems. This demand is driven by the increasing number of electrical components in modern aircraft, the rising complexity of aircraft systems, and the exponential growth in data generated by these systems. This trend is particularly pronounced in critical areas such as engines, structural elements, avionics modules, and hydraulic or pneumatic systems, where accurate and continuous monitoring is essential to ensure the safety and reliability of the aircraft. In response to these challenges, the industry has developed aircraft subsystems (e.g., including aircraft components) life cycle monitoring systems designed to handle the high volume of data generated by these components and manage their life cycles effectively. One common approach has been to leverage significant computing resources (e.g., at a ground station) to collect these data from the aircraft and process the data efficiently. For example, these traditional aircraft subsystems (e.g., including aircraft components) life cycle monitoring systems often incorporate high densities of semiconductor devices, such as advanced processors and memory units, to enhance computational and storage performance. While these systems improve data processing capabilities, they are still constrained by several technical limitations. For instance, the traditional aircraft subsystems (e.g., including aircraft components) life cycle monitoring systems often rely on reactive maintenance strategies, addressing issues only after anomalies are detected during scheduled inspections or following component failures. This reactive approach results in unplanned downtime, increased operational costs, and elevated safety risks, as emerging issues may not be identified early enough to prevent critical failures. Furthermore, these traditional systems lack real-time data acquisition and analysis capabilities. While basic health indicators can be monitored in-flight, detailed diagnostics and trend analyses are typically performed on the ground after manual data retrieval, delaying the detection of rapidly developing issues. This delay is particularly detrimental to the monitoring of critical components like engines and avionics. Traditional systems also rely heavily on fixed baseline performance parameters that are established during the design and manufacturing stages. While these baselines are useful for initial diagnostics, they fail to adapt to changing operational environments, component aging, or evolving failure modes. Consequently, these systems are unable to account for gradual degradation patterns or the cumulative impact of wear and tear. Additionally, while traditional systems can detect existing faults, they often lack the predictive capabilities needed to forecast future failures. This limitation is particularly problematic for components where early signs of degradation are subtle and require advanced analytics to identify. Without predictive capabilities, these systems increase the risk of unexpected failures and reliance on reactive maintenance. As a result, traditional aircraft subsystems (e.g., including aircraft components) life cycle monitoring systems face significant challenges in predicting component failures at an early stage. Their limitations in real-time monitoring and analysis, coupled with their inability to provide real-time predictions during aircraft operations, make them inadequate for managing the growing complexity and demands of modern aircraft systems. Advanced technical solutions are needed to address these challenges, leveraging real-time data acquisition, predictive analytics, and adaptive monitoring capabilities to enhance the reliability, safety, and efficiency of aircraft subsystems (e.g., including aircraft components) life cycle management.

### DISTRIBUTED NEURAL NETWORK FOR MANAGING LIFE CYCLE OF AIRCRAFT SUBSYSTEMS E.G., INCLUDING AIRCRAFT COMPONENTS

This disclosed technology relates to a distributed neural network for monitoring aircraft. Monitoring aircraft(s), as disclosed herein, refers to monitoring aircraft operations, including determining the state of health of the aircraft (e.g., one or more components and systems of the aircraft). In some examples, monitoring the aircraft includes determining the remaining life-cycle of the aircraft subsystems (e.g., including aircraft components) and subsystems. For the purpose of description, an early stage failure refers to a failure of a subsystem (or any component) thereof that is premature relative to expected lifetime of such subsystem or the component as indicated by, e.g., the manufacturer. The early stage notification can be inferred from an indication of an initial phase performance degradation and/or malfunctions of the aircraft. The state of health of the aircraft, as disclosed herein, refers to a comprehensive evaluation of the current condition and operational performance of the aircraft. As will be disclosed herein, the state of health of the aircraft can be predicted by performing a deep learning process (e.g., by using a cloud-side neural network model) by utilizing more extensive data than the learning process (e.g., by using an edge -side neural network model) used to determine the early stage notification, e.g., early stage failure notification.

In some embodiments, a distributed neural network disclosed herein is configured to monitor the aircraft. The distributed neural network includes an edge-side neural network system onboard the aircraft for real-time anomaly detection and data processing and a cloud-side neural network system on a ground station for advanced analytics and model optimization. Because the computing resources on the aircraft can be more limited relative to the ground station, the edge-side neural network system has a relatively lightweight neural network model compared to a neural network model embedded in the cloud-side neural network system. The cloud-side neural network system dynamically updates the edge-side neural network model embedded in the edge-side neural network system by, e.g., providing updated or refined coefficients as further input to the edge-side neural network model, thereby enabling continuous alignment with the latest predictive models and ensuring efficient and reliable operation of the aircraft.

To facilitate an understanding of the systems and methods discussed herein, several terms are described below. These terms and other terms used herein should be construed to include the provided descriptions, the ordinary and customary meanings of the terms, and/or any other implied meaning for the respective terms, wherein such construction is consistent with the context of the term. Thus, the descriptions below do not limit the meaning of these terms but only provide example descriptions.

As disclosed herein, the life cycle of an aircraft subsystems (e.g., including aircraft components) refers to the sequential stages that represent the current state and progression of the components throughout their operational lifespan. This includes evaluating the reliability of the aircraft subsystems (e.g., including aircraft components) by predicting the likelihood of failures, such as functional failures or physical degradation. Additionally, the life cycle encompasses the prediction of the remaining useful life of the components.

As disclosed herein, artificial intelligence (AI) refers to the development of computational systems that can simulate intelligent human behavior, such as reasoning, learning, and decision-making. In the context of this disclosure, AI encompasses machine learning and neural network models designed to analyze vast datasets, detect patterns, and make accurate predictions regarding the operational health of aircraft subsystems (e.g., including aircraft components).

As disclosed herein, neural networks refer to computational models with a plurality of layers of interconnected nodes (neurons) that process input data by applying weighted connections, non-linear activation functions, and iterative optimization techniques. The neural networks employed in the disclosed systems are specifically designed to analyze sensor data from aircraft systems, extract meaningful features, and predict potential anomalies or failures.

As disclosed herein, aircraft subsystems (e.g., including aircraft components) refer to structural elements of a subsystems of an aircraft, including engines, avionics modules, landing gear, hydraulic systems, pneumatic systems, and electrical systems. These components are critical to the safe operation of the aircraft.

As disclosed herein, the ground station is a dedicated facility equipped with high-performance computing resources that communicate with the aircraft to perform advanced analytics on aggregated operational data. The ground station hosts the cloud-side neural network, which processes fleet-wide datasets and provides centralized computational support for the AI-driven aircraft monitoring system.

As disclosed herein, the edge-side neural network is a lightweight onboard AI module implemented within the aircraft to perform real-time anomaly detection and data processing. By continuously monitoring the operations of the aircraft's electrical and mechanical components, the edge-side neural network ensures immediate responsiveness to emerging issues. The edge-side neural network is optimized for compactness and efficiency, enabling integration into the aircraft's systems with minimal computational resource requirements.

As disclosed herein, the cloud-side neural network, hosted in the ground station, performs advanced analytics using extensive computational resources. This cloud-side neural network processes aggregated data from edge-side neural networks of individual aircraft and fleet-wide datasets to identify deeper insights and predictive trends that are not immediately discernible from localized data. The cloud-side neural network dynamically generates updated model coefficients of the edge-side neural network for each aircraft based on its analysis, representing refined learning parameters that enhance the predictive performance of the edge-side neural network.

As disclosed herein, computing resources refer to the hardware and software capabilities required for data processing, including central processing units (CPUs), graphics processing units (GPUs), tensor processing units (TPUs), neural processing units (NPUs), memory, and storage. The edge-side neural network is designed to operate on lightweight, energy-efficient computing devices with limited resources, suitable for onboard deployment. In contrast, the cloud-side neural network benefits from access to high- performance computing resources at the ground station, enabling it to handle large-scale computations and process complex datasets. A central processing unit (CPU) can refer to a processing component that performs the processing of data by executing instructions, such as performing basic arithmetic, logic control, and input/output operations in accordance with the instructions. The CPU can have various architectures that dictate how the CPU processes data, executes instructions and communicates with other parts of the computer system. However, the present disclosure does not limit the CPU architectures. A tensor processing unit (TPU) can generally refer to a processing unit (e.g., a type of application-specific integrated circuit) specifically designed for accelerating machine learning workloads, such as handling computational requirements of machine learning models (for example, a deep learning algorithm). The TPU can include, without limiting, matrix multiplication units configured to perform matrix multiplications in accordance with the machine learning models, memory configured to support data transfer demanded for machine learning workloads and the like. A neural processing unit (NPU) can generally refer to a processing unit specifically designed for accelerating machine learning and artificial intelligence computations that involve neural networks. For example, the neural network can generally refer to a network having a plurality of nodes and layers, where each node (organized in specific layer(s)) processes data to perform the task, such as data patter reorganization, data classification, output predictions, and the like. The NPU is designed to perform specific types of mathematical operations used in the neural network. The NPU can include a plurality of processing cores configured to execute multiple operations in the neural network parallelly. A graphics processing unit (GPU) can refer to a processing unit designed to accelerate graphics rendering. The GPU can include a plurality of cores configured to perform parallel processing. The GPU can have various architectures based on its operation, such as parallel processing. In addition, the GPU can be implemented as a standalone processing unit or integrated with other processing units, such as the CPU. The present disclosure does not limit the types of GPU architecture and implementation of the GPU.

The disclosed distributed neural network includes neural network models that implement neural network algorithms configured to monitor, predict, and manage the life cycle (e.g., failure detection and reliability) of aircraft subsystems (e.g., including aircraft components) throughout their entire product life cycle. The distributed neural network disclosed herein includes an edge-side neural network system implemented within the aircraft and a cloud-side neural network system hosted on a ground station. The edge-side neural network system is designed to operate onboard the aircraft and is capable of performing real- time anomaly detection and data processing by continuously monitoring the operations of the aircraft's electrical and mechanical components. This onboard system is optimized for compactness and efficiency, enabling it to function with limited computational resources while maintaining a small form factor suitable for integration into aircraft systems. The cloud-side neural network system, which operates within a ground station communicatively coupled with the aircraft, leverages extensive computational resources to perform advanced analytics. This cloud-side neural network system processes aggregated data from aircraft and fleet-wide datasets, allowing for deeper and more comprehensive insights. The cloud-side neural network system dynamically generates updated model coefficients based on its analysis for its own neural network as well as for the edge-side neural network system. The coefficients updated by the cloud-side neural network system for the edge-side neural network system, which represent the learned parameters of the neural network, are transmitted to the edge-side neural network system in real or near real-time to update the edge-side neural network model included in the system. This continuous update loop ensures that the edge-side neural network system remains aligned with the latest predictive models, even as new patterns or failure modes emerge. The edge-side neural network system is designed to demand fewer computational resources than its cloud-based neural network system, allowing for the use of lightweight and energy-efficient computing resources onboard the aircraft. Meanwhile, the cloud-side neural network system can benefit from the availability of high-performance hardware, enabling it to handle complex computations and analyses.

Some traditional aircraft subsystems (e.g., including aircraft components) life cycle monitoring systems face several limitations that make them inadequate for addressing the evolving demands of modern aviation. One significant technical limitation is their reliance on a reactive maintenance approach, where issues are addressed only after anomalies are detected during scheduled inspections or following component failures. This reactive strategy often leads to unplanned downtime, increased operational costs, and potential safety risks because emerging issues may go unnoticed until it is too late to prevent failures. Another limitation is the lack of real-time monitoring capabilities. Traditional systems typically focus on collecting data during flight but defer detailed diagnostics and trend analysis until the aircraft is on the ground. This delay hinders the detection of fast-developing issues, particularly in critical components like engines and avionics, where immediate intervention could prevent escalation. Data management in traditional systems is also siloed, with a focus on individual components or subsystems rather than integrated data analysis across the entire aircraft. This fragmented approach limits the ability to detect complex interdependencies between components and makes it challenging to predict systemic failures that may arise from cascading effects across interconnected systems. Moreover, these systems often rely on static baseline performance parameters established during the design and manufacturing stages. While these baselines are useful for initial diagnostics, they fail to adapt to real-world changes such as varying operational environments, component aging, or evolving failure modes, which can obscure early signs of degradation.

In some cases, the traditional systems depend heavily on scheduled inspections, with maintenance actions tied to either distance- or time-based fixed intervals rather than the actual condition of components. This time-based approach often results in unnecessary maintenance of components that are still in good condition or insufficient maintenance of those that are deteriorating faster than anticipated due to specific operational conditions. Compounding this issue is the inability of traditional systems to process and analyze the vast volumes of data generated by modern aircraft. These systems lack the computational capabilities to manage the increasing data complexity, velocity, and variety, which limits their ability to deliver actionable insights in real-time or near real-time. In addition, the traditional systems have a limited ability to predict future failures. While they can detect existing faults, they often miss subtle signs of early stage degradation that require advanced analytics to identify. This inability to predict failures increases the risk of unexpected component malfunctions, leading to reactive rather than proactive maintenance. Additionally, these systems are typically designed to operate at the level of individual aircraft and do not leverage fleet-wide data, missing opportunities to identify trends, common failure modes, or best practices that could be derived from aggregated analysis across multiple aircraft. Furthermore, the traditional systems are also ill-suited for the complexity of modern aircraft, which increasingly rely on highly integrated electrical, mechanical, and software-driven systems. The interdependence of these systems introduces new challenges that traditional monitoring frameworks may not equipped to address, leading to significant blind spots in diagnostics and monitoring.

To address these and other needs of the aircraft subsystems (e.g., including aircraft components) life cycle monitoring technology, aspects of the present disclosure provide various embodiments of a novel distributed neural network by utilizing neural network models embedded in an edge-side neural network system and a cloud-side neural network system of the architecture.

The disclosed distributed neural network provides an edge-side neural network system and a cloud-side neural network system, and these two systems combine computational workloads across edge-side (e.g., implemented in an aircraft) and cloud-side (e.g., implemented in a ground station) of the neural network models. In various aspects, this distributed neural network leverages the localized real-time processing in the aircraft and the centralized high performance analytics at the ground station.

In some embodiments, the disclosed distributed neural network is designed to detect abnormalities in aircraft subsystems (e.g., including aircraft components) at an early stage by continuously monitoring their operations in real-time. For example, the edge-side neural network system, deployed onboard the aircraft is responsible for real-time anomaly detection and localized data processing. For example, the edge-side neural network receives as its input sensor data from various aircraft subsystems (e.g., including aircraft components) and/or systems, including engines, avionics, structural elements, and hydraulic systems. By processing this data in real-time, the edge-side neural network can determine the early stage of failure, for example, by detecting deviations from normal operating conditions of the components and systems. In some examples, the edge-side neural network can be configured to monitor the sensor data based on predefined criteria (e.g., predetermined early stage notification criteria) for each aircraft subsystem to generate an early stage notification such that the edge-side neural network can include predefined early stage notification criteria of each subsystem, and the early stage notification can be generated if the sensor data (e.g., output of the sensor) satisfies, e.g., triggers, the predefined early stage notification criteria. For the purpose of description, the criteria can refer to expected performance or operational parameters of subsystems predefined by the aircraft manufacturer, administrator, and/or operators of the aircraft.

In some examples, the edge-side neural network system is optimized for compactness and efficiency, utilizing a lightweight and energy-efficient model to address the computational and memory constraints typically associated with aircraft systems. For example, while the edge-side neural network system may be configured for deep learning, the computational intensity can be scaled down by reducing the number of hidden layers and/or neurons per hidden layer to match the specific monitoring requirements of critical components of the aircraft during flight. For instance, an edge-side neural network can be scaled to monitor engine and hydraulic components, which are deemed critical for safe operation, enabling immediate detection of anomalies in these subsystems during flight.

Generally described, the neural network models (e.g., the edge-side neural network model and the cloud-side neural network model) incorporate multiple hidden layers, each containing interconnected neurons that process data inputs. Neurons in each layer compute weighted sums of their inputs, where the coefficients (also called as "weights") and biases determine the influence of each input. These computations are followed by the application of activation functions, which introduce non-linearity and enable the network to model complex patterns in sensor data. The coefficients, representing the learned parameters of the neural network, are optimized during training, and updated dynamically to improve predictive accuracy and adaptability. In addition, the number of layers and neurons is proportionally correlated with the demand for the computing resources, such that the higher the number of layers and neurons, the demand for more computing resources. As disclosed herein, the cloud-side neural network system includes more layers and neurons than the edge- side neural network system.

The edge-side neural network's hardware implementation is configured to meet the aircraft's specific installation requirements. Lightweight, energy-efficient components, such as low-power CPUs, embedded GPUs, TPUs, or NPUs, can be used to ensure the system operates reliably within the aircraft's power and space limitations. This scaling capability is particularly advantageous, as aircraft have strict constraints on onboard hardware and power generation. In some cases, the edge-side neural network's configuration can be dynamically adjusted based on the type of aircraft, allowing for further customization and optimization of its functionality.

In some embodiments, the disclosed distributed neural network includes a cloud-side neural network system hosted at a ground station. This cloud-side neural network system performs advanced analytics on aggregated data from multiple aircraft, each equipped with its own edge-side neural network. The cloud-side neural network system processes large volumes of data, including real-time inputs transmitted from aircraft, historical logs, and fleet- wide datasets. By leveraging extensive computational resources, such as high-performance CPUs, GPUs, and distributed storage systems, the cloud-side neural network system identifies patterns, trends, and predictive insights that may not be immediately discernible at the edge- side neural network system. This centralized processing capability enables the detection of fleet-wide trends, the identification of new failure modes, and the analysis of operational conditions that may affect component reliability.

To mitigate the relatively limited compute power on the edge side, the disclosed distributed neural network system also provides a dynamic exchange of model coefficients between the cloud-side and edge-side neural network models. For instance, during flight, the edge-side neural network system can receive an updated neural network model or coefficients that are generated by the cloud-side neural network system. The cloud-side neural network system refines predictive models by analyzing large datasets, including real-time sensor data and operational statuses received from multiple aircraft, as well as fleet-wide historical logs. This process ensures that the edge-side neural network remains aligned with the latest predictive insights and modeling techniques.

In some cases, the edge-side neural network model included in the edge- side neural network system includes multiple hidden layers, each composed of neurons configured with coefficients representing weights and biases. These coefficients determine the strength and direction of influence between neurons and are critical for accurate anomaly detection and prediction. The cloud-side neural network model included in the cloud-side neural network system continuously refines these coefficients through advanced analytics and optimization techniques, such as backpropagation and gradient descent. The updated coefficients are transmitted to the edge-side neural network system in real or near real-time, ensuring that the onboard system remains up-to-date with the latest model improvements. This dynamic update loop allows the edge-side neural network model to adapt to evolving operational conditions, enhancing its ability to detect emerging issues and maintain optimal performance.

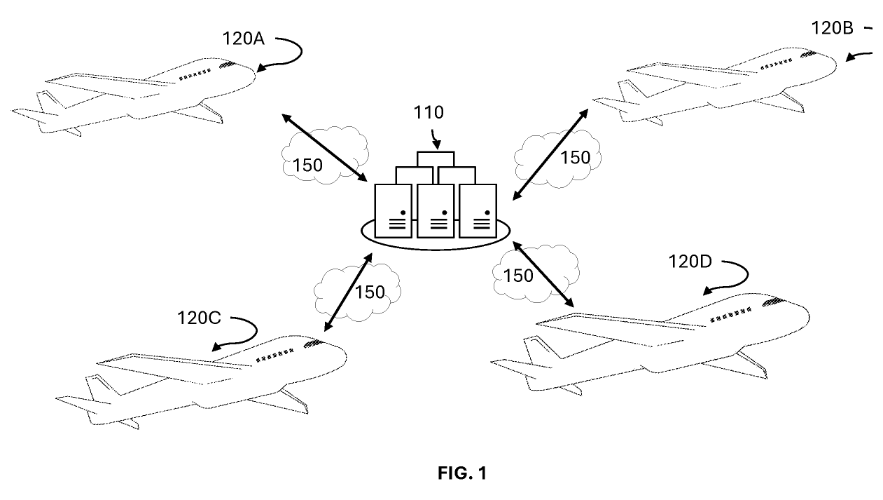

FIG. 1 illustrates an example environment of a ground station 110 communicatively coupled with multiple aircraft 120A-120Din accordance with the embodiments disclosed herein. For the purpose of illustration, four aircraft 120A-120Dare depicted in FIG. 1. However, the types and numbers of aircraft shown are not limited, and the system can accommodate various numbers and types of aircraft based on the specific application and operational requirements. The ground station 110, as disclosed, generally refers to an aircraft maintenance, operational, or administrative facility or any similar infrastructure designed to manage or oversee aircraft systems. This facility is equipped to perform tasks such as aircraft maintenance, operations management, and data analytics. The present disclosure does not limit the types or configurations of such facilities. As illustrated in FIG. 1, the aircraft 120A-120Dare communicatively connected to the ground station 110 via a network 150. The network 150 is a wireless communication network that supports various commercial wireless communication protocols. These protocols include satellite communication (SATCOM), which utilizes satellite communication channels for global coverage; very high frequency (VHF) or high frequency (HF) radio systems, which operate on specific frequency bands to facilitate communication over medium to long distances; and air- to-ground (ATG) networks, which provide high-bandwidth communication over shorter ranges with terrestrial infrastructure. The types of wireless communication protocols used by the network 150 are not limited in the present disclosure and can be selected based on the specific wireless communication environment and operational requirements. For example, SATCOM may be preferred for transoceanic flights, while ATG networks may be utilized for domestic routes with adequate ground coverage.

In accordance with some embodiments, a distributed neural network is implemented across the ground station 110 and the aircraft 120A-120D. Each of the aircraft120A-120D can be equipped with an edge-side neural network system that includes the edge-side neural network model that processes sensor data generated by components onboard the aircraft. These sensors, which may be installed in engines, avionics systems, structural elements, hydraulic systems, and other critical subsystems, continuously collect operational data. The edge-side neural network onboard each aircraft monitors this data in real-time to detect anomalies and deviations from normal operating conditions, ensuring immediate responsiveness to emerging issues. The edge-side neural network system is also configured to transmit processed or aggregated data to the ground station 110 via the network 150. This transmission enables the system to leverage the cloud-side neural network hosted at the ground station for advanced analytics. Although the present disclosure describes scenarios in which all aircraft are equipped with an edge-side neural network system, this description is provided merely as an example and is not intended to be limiting. It is not necessary for every aircraft to include an edge-side neural network system. For instance, in a scenario involving multiple aircraft, at least one aircraft may implement the edge-side neural network system connected to a cloud-side neural network system and perform the functionalities disclosed herein.

The cloud-side neural network system include the cloud-side neural network model that processes the received data alongside fleet-wide historical logs, real-time inputs from other aircraft, and operational datasets. By performing these advanced analyses, the cloud-side neural network system can identify fleet-wide trends, predict the life cycle of aircraft subsystems (e.g., including aircraft components), and optimize neural network models. In some embodiments, the cloud-side neural network system (e.g., the neural network model included in the system) dynamically generates updated model coefficients for the edge-side neural networks. These coefficients represent refined weights and biases derived from advanced analytics and are transmitted back to the aircraft in real or near real-time via the wireless network 150. This dynamic exchange ensures that the edge-side neural networks onboard the aircraft remain synchronized with the latest predictive insights and models generated by the cloud-side neural network, enabling adaptive monitoring and improved anomaly detection capabilities.

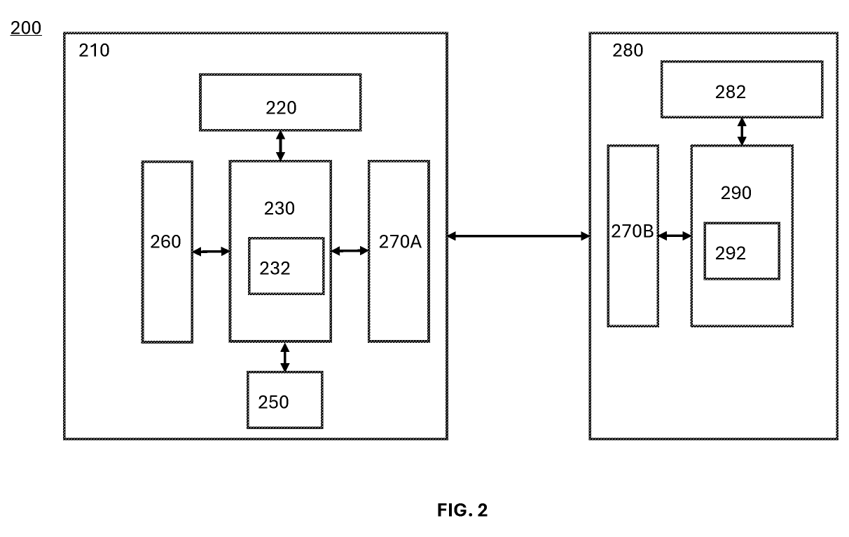

FIG. 2 illustrates an example block diagram of a distributed neural network 200. In some embodiments, the distributed neural network 200 includes an edge-side neural network system 210 and a cloud-side neural network system 280. The edge-side neural network system 210 is implemented in one or more aircraft 120A-120D (FIG. 1), and the cloud-side neural network system 280 is implemented in the ground station 110.

The edge-side neural network system 210 can be a comprehensive onboard system designed for monitoring aircraft, and include an early stage notification system such as an early stage failure detection (e.g., anomaly detection) system of the aircraft. The edge-side neural network system 210 may include an edge-side local processor 220, an edge-side local memory 230, a power supply unit 250, an internal sensor module 260, and an edge-side wireless communication block 270A. In some embodiments, the edge-side local memory 230 is configured to store the edge-side neural network model 232, and the edge-side local processor 220 can be adapted to execute the edge-side neural network model 232.

In some embodiments, the edge-side local processor 220 is a local processor, such as the central computational unit of the edge-side neural network system 210. The edge- side local processor 220 is configured to execute various instructions, including those generated and provided by the edge-side neural network model 232. For instance, the edge- side local processor 220 is configured to execute the edge-side neural network model 232 included in the edge-side local memory 230 and handle real-time data processing tasks associated with monitoring and analyzing sensor data from the aircraft.

The edge-side local processor 220 can be implemented using one or more types of computational units, such as CPUs (central processing units), GPUs (graphics processing units), TPUs (tensor processing units), and/or NPUs (neural processing units). In some embodiments, the edge-side local processor 220 may leverage computing units already integrated into the existing aircraft system, such as onboard computing devices that form part of the aircraft's avionics suite. The selection and configuration of the edge-side local processor 220 are determined based on the computational intensity demanded by the instructions (or workloads) generated from the edge-side local memory 230.

For example, if the edge-side local memory 230 has stored therein neural a neural network model configured for high computational workloads, such as the edge-side neural network model 232 with a large number of hidden layers or neurons, the edge-side local processor 220 may be scaled to increase the number of processing units or enhanced computational resources to efficiently execute these workloads. The specific configuration of the edge-side local processor 220 is also influenced by the aircraft's operational constraints, including power supply availability, physical space, and thermal capacity. These factors ensure that the edge-side local processor 220 is seamlessly integrated into the aircraft system without compromising overall performance or resource efficiency. In some embodiments, the edge- side local memory 230 is communicatively coupled with the internal sensor module 260 and configured to receive sensor data (e.g., measured value of each sensor from the sensors embedded in the aircraft) generated from the internal sensor module 260. In addition, the edge- side local memory 230 is also communicatively coupled with the edge-side wireless communication block 270A and transmits the received sensor data to the cloud-side neural network system 280 via the edge-side wireless communication block 270A. In some examples, the edge-side local memory 230 can also obtain data, such as updated coefficients of the edge- side neural network model 232, and update the coefficients of the edge-side neural network model 232 with the newly received updated coefficients (e.g., by executing instruction for the edge-side local processor to update the coefficients).

In some embodiments, the edge-side local memory 230 may be implemented as a standalone dedicated memory hardware component, specifically designed to store the edge-side neural network model 232. In alternative embodiments, the edge-side local memory 230 may be implemented as a memory component of the aircraft onboard system. The present disclosure does not limit the specific implementation of the edge-side local memory 230.

In some embodiments, the edge-side local memory 230 stores the edge-side neural network model 232 that generates operational instructions. For example, the operational instructions can include instructions to receive sensor data in real time from a plurality of sensors installed on the aircraft for sensing operational parameters of the aircraft, where the received sensor data can be utilized as an input to the edge-side neural network model 232. The instruction can also include instructions to classify the sensor data to determine whether one or more of the sensor data is indicative of an early stage notification criteria of one or more systems or components. For example, the edge-side neural network model 232 can inference operational patterns of one or more components and/or systems of the aircraft by classifying the received sensor data. In this example, the edge-side neural network model 232 can be configured to generate an early stage notification by comparing the inferenced operational patterns with operational patterns that indicates the early stage notification criteria. In some examples, the instruction can also include providing the sensor data and the classified subset of the sensor data as an output of the edge-side neural network model to the cloud-side neural network system 280.

In some examples, the edge-side neural network model 232 can be configured for deep learning to update at least some of its own parameters based on the sensor data. These parameters refer to the coefficients associated with each neuron in the edge-side neural network model 232, such as the weights and biases. The values of these coefficients are correlated with determining the output of the edge-side neural network model 232. For instance, the coefficients influence how the model classifies sensor data, which can lead to variations in determining early stage notifications (e.g., for example, by detecting early stage failure). Additionally, the coefficients affect the model's ability to infer operational patterns based on sensor data. This influence can result in variations in the inferred operational patterns of the aircraft subsystems (e.g., including aircraft components) and systems, directly impacting the accuracy and reliability of determining whether generate the early stage notification.

In some embodiments, the edge-side neural network model 232 can be configured to create an edge-side neural network model training set. For example, the edge-side neural network model training set can include at least one of: the state of health of the aircraft, the input sensor data, the classified sensor data, the predetermined early stage notification criteria, the early stage notification, current parameters of the edge-side neural network model, and the updated parameters of the edge-side neural network model. In some examples, one or more neurons and hidden layers of the edge-side neural network model 232 can be dedicated to create the edge-side neural network model training set. In some cases, the edge-side neural network model 232 can be configured to update the neural network parameters (e.g., weight and coefficients of neurons) based on the edge-side neural network model training set. In some examples, the edge-side neural network system is configured for unsupervised training of the edge-side neural network model by using the edge-side neural network model training set. In these examples, the edge-side neural network model training set can include all or any combinations of the state of health of the aircraft, the input sensor data, the classified sensor data, the predetermined early stage notification criteria, the early stage notification, current parameters of the edge-side neural network model, and the updated parameters of the edge- side neural network model.

In some cases, the edge-side local memory 230 includes a random access memory for temporarily storing real-time data processing tasks and also non-volatile memory such as flash or solid state for storing the neural network model, configuration files, historical data logs, and the like. The memory capacity can be scaled to accommodate the data volumes generated by onboard sensors and the computational needs of the neural network model, ensuring seamless performance within the constraints of onboard resources.

The edge-side neural network system is powered by the aircraft's onboard power supply unit 250, and the capacity of the power supply is determined based on the aircraft specification.

Still referring to FIG. 2, the edge-side neural network system 210 also includes an internal sensor module 260. The internal sensor module 260 is configured to obtain sensor data (e.g., the measured value of each sensor) from the sensors embedded in the aircraft. In some embodiments, the aircraft is equipped with an array of sensors designed to monitor various systems and components to ensure safe and efficient operation. These sensors provide real-time data essential for the functioning of critical aircraft systems, as well as for supporting advanced monitoring capabilities such as the edge-side neural network. Sensors in aircraft serve diverse purposes, from tracking flight parameters to monitoring engine health, structural integrity, and environmental conditions. For example, flight control sensors are integral to maintaining aircraft stability and navigation.

The internal sensor module 260 is configured to obtain sensor data from various sensors. For instance, pitot-static sensors measure airspeed, altitude, and vertical speed by analyzing pressure differences, while angle of attack sensors monitor the angle between the wing chord line and the relative airflow, which is crucial for preventing aerodynamic stalls. Gyroscopes and accelerometers provide data on angular velocity and linear acceleration, forming the basis for inertial measurement units that track the aircraft's orientation and movement. These sensors are fundamental for autopilot systems and for pilots to maintain control during flight. Engine sensors are critical for monitoring the performance and health of propulsion systems. Temperature sensors track parameters such as exhaust gas temperature and turbine inlet temperature, which help assess engine efficiency and detect overheating. Pressure sensors measure oil and fuel pressure, ensuring that these vital fluids operate within safe limits, while vibration sensors identify abnormal vibrations, often indicative of mechanical wear or imbalance. Fuel flow sensors monitor the rate of fuel consumption, enabling optimization of engine performance and ensuring sufficient fuel for the intended flight duration. Structural sensors play an important role in maintaining the aircraft's physical integrity. Strain gauges detect stress and deformation in structural elements such as wings and the fuselage, particularly during turbulent conditions or high-load maneuvers. Displacement sensors measure any movement or misalignment in critical structural parts, and load sensors monitor the forces exerted on key components like the landing gear. These sensors help detect potential structural fatigue or failure, ensuring timely maintenance and safety. Hydraulic and pneumatic systems rely on sensors to maintain the performance of control surfaces, landing gear, and braking systems. Pressure sensors monitor the hydraulic fluid's operating pressure, while temperature sensors ensure the system does not overheat. Flow sensors track the rate of hydraulic fluid movement, identifying blockages or leaks that could compromise system functionality. Electrical system sensors monitor the aircraft's power supply and avionics. Voltage and current sensors measure electrical parameters to ensure stable operation of critical systems, while battery condition sensors assess charge levels and overall health. Power quality sensors detect fluctuations or irregularities in the electrical supply, protecting sensitive electronic systems from damage. Environmental sensors enhance the aircraft's ability to adapt to changing atmospheric conditions. Temperature and humidity sensors track external and cabin conditions, while ice detection sensors identify the formation of ice on critical surfaces, such as wings or engine inlets. Weather radar and lightning detection sensors provide data to help pilots navigate hazardous weather conditions, ensuring passenger and crew safety. These sensors are merely provided as examples, and additional sensors can be equipped in the aircraft, and the present disclosure does not limit the specific types and number of sensors equipped in the aircraft.

In some embodiments, the internal sensor module 260 may include a sensor fusion module configured to process received sensor data and enhance its accuracy, reliability, and comprehensiveness. Sensor fusion is a sophisticated process in which data from multiple sensors is combined to generate a unified understanding of the aircraft's state and environment. By integrating diverse data streams, the sensor fusion module leverages the strengths of individual sensors while mitigating their limitations, enabling better decision-making and control in complex, real-time scenarios.

Illustratively, the process of sensor fusion begins with the acquisition of raw data from various sensors, each providing unique information. For instance, accelerometers measure linear acceleration, gyroscopes track angular velocity, GPS modules provide precise positioning, and barometric pressure sensors calculate altitude. These sensors operate simultaneously, collecting data specific to their capabilities. Together, they create a multidimensional view of the aircraft's operational state, such as its position, orientation, and environmental conditions. Before this data can be integrated, it undergoes preprocessing to ensure consistency and usability. Raw sensor readings often contain noise or inconsistencies, which are filtered out. The data is then normalized to a common scale and synchronized to account for differences in sensor frequencies or latencies. Time stamps or alignment mechanisms are used to match data points, ensuring that the fusion process can interpret them accurately. In some scenarios, if an aircraft is flying through an area with weak GPS signals due to interference, sensor fusion enables the system to rely on accelerometers and gyroscopes to maintain accurate navigation and position tracking.

The edge-side neural network system 210 also includes an edge-side wireless communication block 270A that facilitates seamless data exchange between the edge- side neural network system 210 and the cloud-side neural network system hosted at a ground station 110 via the network 150. This edge-side wireless communication block 270A is communicatively coupled with a cloud-side wireless communication block 270B (e.g., included in the cloud-side neural network system 280) and supports multiple wireless protocols, including SATCOM for global coverage, ATG networks for high-bandwidth data transfer over shorter ranges, and VHF/HF radio systems for medium- to long-range communication. The wireless communication block incorporates encryption and compression mechanisms to ensure secure and efficient data transmission and prioritizes critical data, such as detected anomalies or model updates, for real-time or near real-time exchange.

As illustrated in FIG. 2, the distributed neural network 200 includes a cloud- side neural network system 280, which is implemented in a ground station 110 and designed to perform advanced analytics using extensive computational resources. The cloud-side neural network system 280 processes aggregated data from the edge-side neural network systems deployed on individual aircraft, as well as fleet-wide datasets, to derive deeper insights and predictive trends that are not immediately discernible from localized data processed on each aircraft. Additionally, the cloud-side neural network system dynamically generates updated model coefficients for the edge-side neural network model 232 of each aircraft.

The cloud-side neural network system 280 includes a cloud-side processing block 282, a cloud-side local memory 290, and a cloud-side wireless communication block 270B. The cloud-side processing block 282 functions as the central computational unit of the system and is responsible for executing instructions generated from the cloud-side neural network model 292 (e.g., stored in the cloud-side local memory 290). The cloud-side processing block 282 is designed to manage the computational intensity and scalability required for processing large datasets and executing sophisticated neural network operations.

For example, the cloud-side processing block 282 includes high-performance components such as multi-core CPUs, GPUs, TPUs, and NPUs. These units operate within a cloud infrastructure that provides scalability and flexibility, dynamically allocating resources to match workload demands generated by the edge-side neural network system 210.

The cloud-side local memory 290, as shown in FIG. 2, stores a cloud-side neural network model 292. In some embodiments, the cloud-side local memory 290 is implemented as a standalone dedicated local memory, configured to store the cloud-side neural network model 292. The cloud-side neural network model 292 can be configured to predict failure of one or more components or systems of the aircraft and determine parameters of the edge-side neural network model 232 of the aircraft.

In some embodiments, the cloud-side neural network model 292 is configured to receive the output of the edge-side neural network model 232. The output can include sensor data and the classified subset of the sensor data. The sensor data can include the input sensor data received from the plurality of sensors installed in the aircraft. The classified subset of the sensor data can include the processed sensor data by the edge-side neural network model 232 and indicate the early stage notification criteria of the aircraft subsystems (e.g., including aircraft components) and systems.

In some examples, the cloud-side neural network model 292 is configured to perform deep machine learning process by utilizing the output of the edge-side neural network model 232. For example, performing the deep machine learning process can provide prediction of the state of health of the aircraft. For instance, predicting the state of health of the aircraft can include determining predictive failure point of the aircraft subsystems (e.g., including aircraft components) and systems. For example, the cloud-side neural network model 292 can continuously evaluate the current condition of each component and system of the aircraft and predict potential failure point of the components and the systems. Predicting the state of health of the aircraft demands more intensive machine learning processing (e.g., heavy lifting processing) than determining whether to generate the early stage notification. For example, the cloud-side neural network model 292 in predicting the state of health demands inferencing additional attributes, such as inferencing rate of wear or degradation of each component and system of the aircraft, inferencing environmental and operational conditions (e.g., temperature, pressure, altitude, number of landings or take offs, and the like), and also historical data from similar components and systems. In some cases, predicting the state of health of the aircraft may demand aggregating additional data from other fleet of aircrafts. In some cases, the cloud-side neural network model 292 can receive outputs of edge-side neural networks implemented in a plurality of aircraft (e.g., a fleet of aircraft). By utilizing the aggregated data, the cloud-side neural network model 292 is configured to monitor the state of health of the aircraft. In some examples, the cloud-side neural network model 292 can further aggregate operational logs generated from the fleet of aircraft to determine the state of health of the aircraft.

In some embodiments, the cloud-side neural network model 292 is configured to verify the coefficients of the edge-side neural network model 232. As disclosed herein, the cloud-side neural network model 292 is designed with a greater number of layers and/or neurons per layer, allowing it to handle more complex computations and analyses compared to the edge-side neural network model 232. The prediction results for early stage notifications (e.g., for example, early stage failure patterns) generated by the cloud-side neural network model 292 are generally more accurate than those produced by the edge-side neural network model 232 due to the cloud-side neural network model's ability to process aggregated data and identify broader patterns. In these embodiments, the cloud-side neural network model 292 not only verifies the early stage notification predictions generated by the edge-side neural network model 232 but also evaluates the underlying model coefficients of the edge-side network. If the cloud-side neural network model 292 identifies discrepancies between its predictions and those of the edge-side neural network model, it can refine or update the parameters (e.g., weights and biases) of the edge-side neural network model 232 to enhance its accuracy. For example, the cloud-side neural network model 292 can utilize aggregated data from a fleet of aircraft, which includes sensor data, operational logs, and flagged early stage failures from multiple edge-side neural networks. This aggregated data can enable the cloud- side model to generate more comprehensive early stage notification predictions. By comparing these predictions to those of the edge-side neural network model 232, the cloud-side neural network model 292 can validate or adjust the edge-side neural network model's coefficients to ensure alignment with the latest predictive insights and fleet-wide patterns.

In some embodiments, the cloud-side neural network model 292 can be configured to create a cloud-side neural network model training set. For example, the cloud- side neural network model training set can include at least one of: the state of health of the aircraft, the input sensor data, the classified sensor data, the predetermined early stage notification criteria, the early stage notification, current parameters of the edge-side neural network model, and the updated parameters of the edge-side neural network model. In some examples, one or more neurons and hidden layers of the cloud-side neural network model 292 can be dedicated to create the cloud-side neural network model training set. In some cases, the cloud-side neural network model 292 can be configured to update the neural network parameters (e.g., weight and coefficients of neurons) of the cloud-side neural network model 292 based on the cloud-side neural network model training set. In some examples, the cloud- side neural network system is configured for unsupervised training of the cloud-side neural network model by using the cloud-side neural network model training set. In these examples, the cloud-side neural network model training set can include all or any combination of the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems

The cloud-side neural network system 280 also includes a cloud-side wireless communication block 270B that facilitates seamless data exchange with the edge-side neural network system 210 via the network 150. This cloud-side wireless communication block 270B is communicatively coupled with the edge-side wireless communication block 270A and also supports multiple wireless protocols, including SATCOM for global coverage, ATG networks for high-bandwidth data transfer over shorter ranges, and VHF/HF radio systems for medium- to long-range communication. The wireless communication block incorporates encryption and compression mechanisms to ensure secure and efficient data transmission and prioritizes critical data such as detected anomalies or model updates for real-time or near real- time exchange.

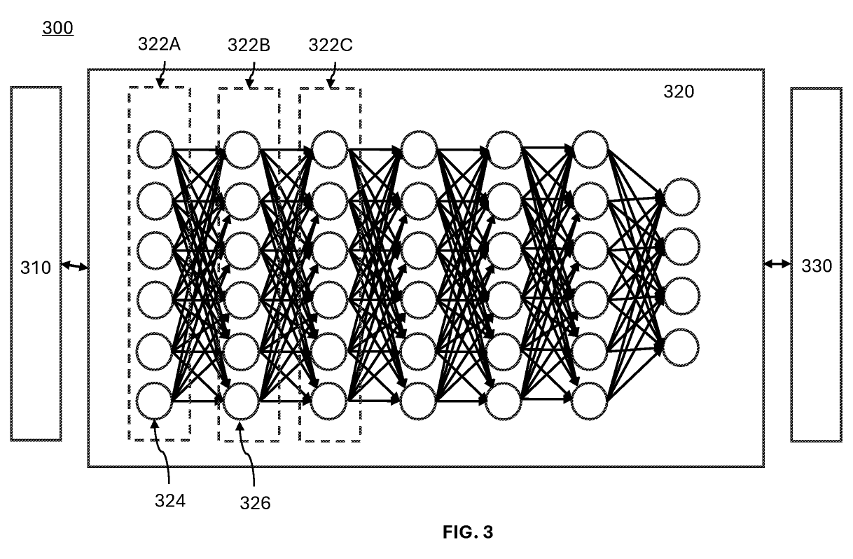

FIG. 3 illustrates an example structure of a neural network model 300. The neural network model 300 can include an input layer 310, one or more hidden layers 320, and an output layer 330. The neural network model 300 includes a set of connected calculation units referred to as "nodes" or "neurons." The nodes (or neurons) forming the neural networks are connected with each other by one or more "links." Each of the nodes in a hidden layer can be an input node to one or more nodes in a later hidden layer, while being an output node to one or more nodes in previous hidden layer. Conceptually, a value of an output node may be determined based on values input to the input nodes connected to the output node and weight set in the link corresponding to each of the input nodes. The neural network model 300 is merely illustrated as an example, and the neural network model 300 can be scaled up or down based on specific applications. For example, the edge-side neural network model 232 and the cloud-side neural network model 292 can be represented by the neural network model 300. In this example, the cloud-side neural network model 292 can be scaled up by adding more hidden layers and/or neurons based on the number of inputs identified from the received (ingested) data from the aircraft (e.g., from the edge-side neural network system 210). In some embodiments, the edge-side neural network model 232 can be scaled down based on the computing resources and power resources available onboard the aircraft.

The input layer 310 is configured to provide input data to the hidden layers 320. For example, the input layer 310 may provide sensor data measured from the sensors installed in various aircraft subsystems (e.g., including aircraft components), such as temperature, pressure, vibration levels, strain levels, and the like.

The hidden layers 320 are where the neural network model 300 extracts patterns and relationships from the input data. The hidden layers can include multiple levels of layers, and the number of layers are determined based on the complexity of input data, the desired level of feature extraction, available computing resources, and the like. For example, predicting the life cycle of the aircraft subsystems (e.g., including aircraft components) can involve modeling intricate relationships between various operational parameters (e.g., measured sensor data) of the aircraft. If the number of operational parameters increase the number of hidden layers 320 can also be increased. For instance, the cloud-side neural network model 292 may obtain the aircraft sensor data from multiple aircraft, so the number of hidden layers 320 of the cloud-side neural network model 292 can be greater than the number of hidden layers 320 included in the edge-side neural network model 232. In some examples, the number of hidden layers 320 can be determined based on the nature of input data. For example, the edge-side neural network model 292 may have certain data, such as temperature, vibration, and pressure, and the hidden layers 320 can extract features related to the life cycle of the aircraft subsystems (e.g., including aircraft components) from each dimension and predict the aircraft subsystems (e.g., including aircraft components)' life cycle (or detect abnormal operations of these aircraft subsystems (e.g., including aircraft components)). In contrast, the cloud-side neural network model 292 may obtain data, such as aircraft operation log data. In this case, the temperature, vibration, and pressure data. In this case, the cloud-side neural network model 292 may need to further analyze the aircraft operation log data to predict the life cycle of the aircraft subsystems (e.g., including aircraft components), thus, the cloud-side neural network model 292 needs more numbers of hidden layers than the edge-side neural network model 232. In another example, the number of hidden layers 320 can be determined based on the desired level of abstraction. For example, if the edge-side neural network model 232 and the cloud-side neural network model 292 receive the same set of input data, such as aircraft temperature, vibration, and pressure, the desired level of abstraction for the edge-side neural network model 232 can be detecting simple patterns such as identifying temperature spikes pattern and vibration levels and determining the effect of these patterns under the aircraft operational condition. In this example, the cloud-side neural network model 292 may be further configured to determine long-term degradation patterns across the aircraft subsystems (e.g., including aircraft components). In this example, the cloud-side neural network model 292 needs more numbers of hidden layers than the edge-side neural network model 232. In another scenario, the number of hidden layers 320 can be determined based on the available computing resources. For example, the number of hidden layers of the edge-side neural network model 232 can be determined based on the available computing resources of the edge-side computing block 282. Likewise, the number of hidden layers of the cloud-side neural network model 292 can be determined based on the available computing resources of the cloud-side computing block 282. In various embodiments, the available computing resources of the cloud-side computing block 282 can be scaled based on the demanded hidden layers 320, thus, the cloud- side neural network model 292 can include greater numbers of hidden layers than the edge- side neural network model 232. In some example embodiments, the number of hidden layers included in the edge-side neural network model 232 can be in a range of 10-100, 100-1000, 1000-10000, 10000-100000, 100000-1 million, 1 million - 10 million. In some cases, the edge- side neural network model 232 can be scaled to include more than 10 million hidden layers based on specific applications. In some examples, the number of hidden layers included in the cloud-side neural network model 292 can be the same or greater as the number of hidden layers included in the edge-side neural network model 232. In some cases, the number of hidden layers included in the cloud-side neural network model 292 can be greater than the number of hidden layers included in the edge-side neural network model 232, such as by 2-10 times, 10- 100 times, 100-1000 times, 1000-10000 times, 10000 - 100000 times, or 100000 - 1 million times than the number of hidden layers included in the edge-side neural network model 232. In addition or alternatively, an average number of neurons per layer in the cloud-side neural network model 292 can be greater than an average number of neurons per layer in the edge- side neural network model 232, such as by 2-10 times, 10-100 times, 100-1000 times, 1000- 10000 times, 10000 - 100000 times, or 100000 - 1 million. In some examples, the edge-side neural network model has less than half of an average number of neurons per hidden layer relative to an average number of neurons per hidden layer of the cloud-side neural network model.

As illustrated in FIG. 3, each hidden layer can include one or more neurons. For example, the hidden layer 322A can include six neurons 324. In some embodiments, each neuron 324 can represent features extracted from a previous layer, which can be an input layer or a previous hidden layer. For example, each neuron 324 included in the hidden layer 322A can represent a corresponding input (e.g., a measure sensor data) received from the input layer 310. For instance, each neuron 324 in the hidden layer 322A may represent engine temperature, engine vibration, engine pressure, left wing vibration, and tail wind direction, respectively. In some examples, each neuron in a subsequent hidden layer obtains inputs from all neurons in the previous layer. For example, each neuron 326 in hidden layer 322B receives input from all the neurons in the hidden layer 322A. For example, each neuron 326 receives that engine temperature, engine vibration, engine pressure, left wing vibration, and tail wind direction. In this subsequent hidden layer, the neurons process the data obtained from neurons in the previous layer to extract patterns. For example, each neurons 326 may extract, from the input data received from neurons in hidden layer 322A, the operational status of the engine, left wing, right wing, and tail wing. Such extraction can also be referred to as inference and can be performed by defining coefficient or weight to each neuron. The hidden layers can progressively extract more meaningful features. For example, the hidden layer 322A detects simple operational patterns of aircraft subsystems (e.g., including aircraft components), and the hidden layer 322B may inference how these operational patterns related to wear and tear of the aircraft subsystems (e.g., including aircraft components). Then, the hidden layer 322C may inference how the wear and tear of the aircraft subsystems (e.g., including aircraft components) affects the degradation performance of the aircraft subsystems (e.g., including aircraft components).

In some instances, the coefficients or weights of each neurons are adjustable parameters based on training of the neural network. For example, the coefficient or weight of each neuron can be recalibrated to minimize the difference between the predicted output and the actual output. For example, if the edge-side neural network model 232 generates output that the vibration on an engine blade is in a normal range, however, if the cloud-side neural network model 292 generates an output that the engine vibration is not in the normal range by further inferencing based on the numbers of the takeoff and landing operations of the aircraft, the coefficient or weight of the neurons included in the hidden layers of the edge-side neural network model 232 can be updated to reflect the data generated by further inferencing the numbers of the takeoff and landing operations of the aircraft.

The output layer 330 is configured to generate the final result of the neural network's computation. The various examples disclosed with respect to FIG. 3 are merely provided as examples without limitation.

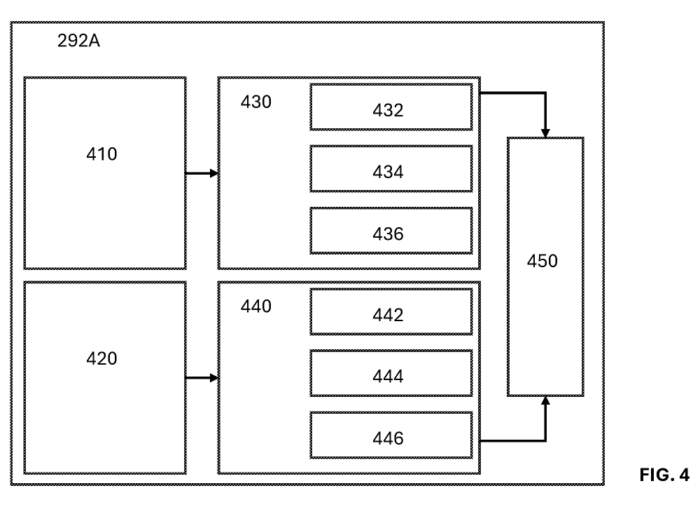

FIG. 4 illustrates a block diagram of an example cloud-side neural network model 292A, designed to detect failures in aircraft subsystems (e.g., including aircraft components) by processing sensor data obtained from edge-side neural network systems 210 deployed on aircraft. The cloud-side neural network model 292A incorporates multiple advanced analytical modules to provide accurate and comprehensive aircraft state of health monitoring and failure detection. These modules include an autocorrelation module 410, a convolutional neural network (CNN) for state-of-health monitoring module 430, a cross- correlation module 420, a CNN for reliability modeling module 440, and a failure detection module 450.

The cloud-side neural network model 292A integrates these modules into a framework for detecting failures by combining the strengths of autocorrelation analysis, cross- correlation evaluation, and convolutional neural networks. The autocorrelation module 410 is connected to the CNN for state-of-health monitoring module 430, while the cross-correlation module 420 is connected to the CNN for reliability modeling module 440. The outputs from these modules are synthesized in the failure detection module 450 to generate failure detection or prediction results for aircraft subsystems (e.g., including aircraft components).

The autocorrelation module 410 analyzes the time-series data of individual aircraft subsystems (e.g., including aircraft components) to identify periodic patterns, trends, and anomalies. This process involves measuring the correlation of each sensor signal with a lagged version of itself, enabling the detection of recurring behaviors or gradual degradation. The results from the autocorrelation analysis are forwarded to the CNN for state-of-health monitoring module 430. The CNN for state-of-health monitoring module 430 processes these results to determine the state-of-health of the aircraft subsystems (e.g., including aircraft components) by categorizing the data into three subsystems: a mechanical subsystem 432, a thermal subsystem 434, and an electrical subsystem 436. Hidden layers within the CNN for state-of-health monitoring module 430 are specifically assigned to each subsystem to extract relevant features. For instance, hidden layers assigned to the mechanical subsystem 432 may identify wear patterns in structural components, while those for the thermal subsystem 434 analyze heat dissipation and temperature trends, and layers for the electrical subsystem 436 monitor voltage and current irregularities. For example, the state-of-health of the aircraft subsystems (e.g., including aircraft components) (e.g., individual aircraft subsystems (e.g., including aircraft components)) refers to an assessment of the current condition and operational performance of each aircraft subsystems (e.g., including aircraft components) based on its expected or optimal performance. The inferred state-of-health, categorized by subsystem, is then provided to the failure detection module 450.

Simultaneously, the cross-correlation module 420 evaluates relationships between sensor data from different components or systems. By quantifying the similarity between two sensor data as a function of time lag, the cross-correlation module 420 identifies interdependencies and cascading failure modes. For example, the cross-correlation module 420 might infer how fluctuations in hydraulic pressure correlate with engine vibrations. The quantified similarities are transmitted to the CNN for reliability modeling module 440, where patterns indicating systemic issues or failures caused by interactions between components or systems are identified. The CNN for reliability modeling module 440 uses its hidden layers to model the reliability of aircraft subsystems (e.g., including aircraft components) by categorizing data into three subsystems: a mechanical subsystem 442, a thermal subsystem 444, and an electrical subsystem 446. Hidden layers specifically assigned to each subsystem extract features that infer reliability and detect potential failure patterns. For example, hidden layers for the mechanical subsystem 442 may identify dependencies between structural wear and environmental conditions, while the thermal subsystem 444 evaluates the effects of overheating, and the electrical subsystem 446 focuses on detecting circuit instabilities. The reliability of the aircraft subsystems (e.g., including aircraft components) refers to each aircraft subsystems (e.g., including aircraft components)'s ability to perform its intended function under the specific operating condition over a defined period without failure. For example, the CNN for reliability modeling module 440 can determine the reliability of the aircraft subsystems (e.g., including aircraft components) (e.g., by categorizing the components into the three subsystems) over the flight duration.

The failure detection module 450 synthesizes the outputs from both the CNN for state-of-health monitoring module 430 and the CNN for reliability modeling module 440. Hidden layers in the failure detection module combine these inferences using weighted connections optimized during training to produce the final failure detection result. This result may include classifications such as "immediate maintenance required," "monitor closely," or "no action needed," as well as probabilities indicating the likelihood of failure for specific components.

For example, the system might detect periodic vibration patterns from an engine using the autocorrelation module 410 and identify the vibration's gradual increase as a sign of bearing wear through the CNN for state-of-health monitoring module 430. Simultaneously, the cross-correlation module 420 might find a strong relationship between hydraulic pressure fluctuations and engine vibrations, which the CNN for reliability modeling module 440 interprets as a cascading failure risk. The failure detection module 450 integrates these insights to generate a unified prediction, such as "engine failure probability: 85%, recommend immediate maintenance."

### DISTRIBUTED NEURAL NETWORK WORKFLOWS

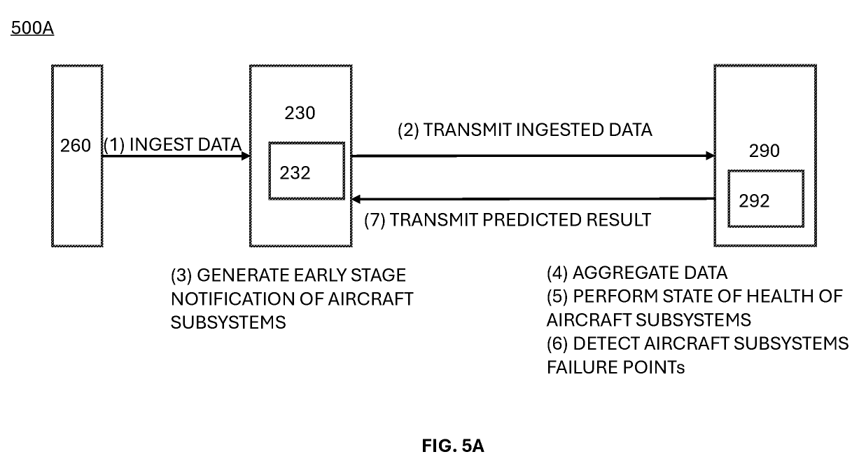

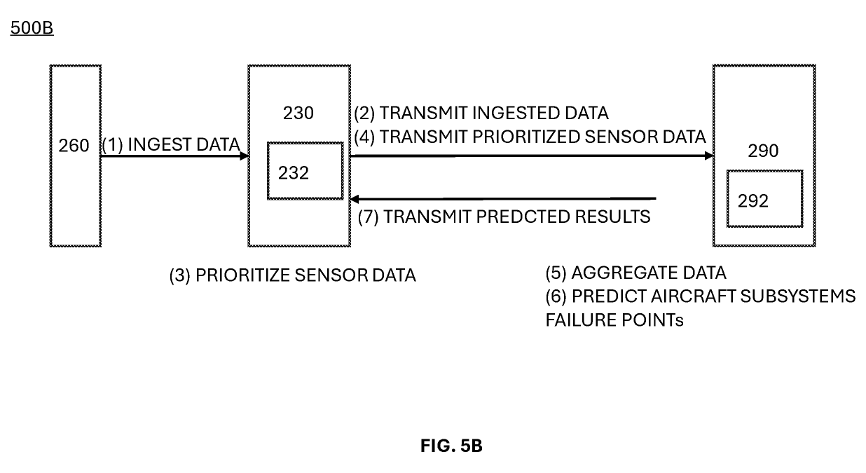

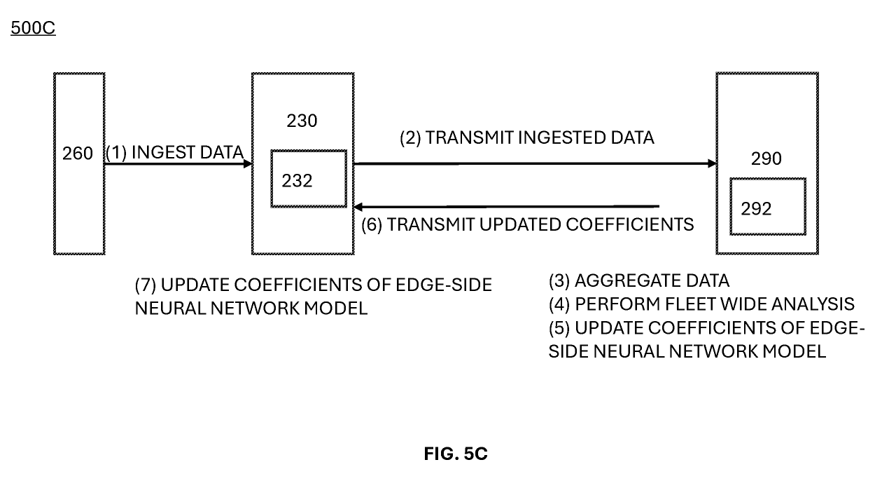

FIGS. 5A-5C illustrates example embodiments of distributed neural network 200 workflows. For the purpose of illustrations, certain elements of the distributed neural network 200 are illustrated in FIGS. 5A-5C. However, one or more workflows illustrated in FIGS. 5A-5C are performed by utilizing the elements illustrated in FIG. 2. For example, the edge-side neural network model 232 and the cloud-side neural network model 292 are executed by the edge-side local processor 220 and the cloud-side processing block 282, respectively. In addition, the communication between the edge-side neural network model 232 and the cloud- side neural network model 292 are communicatively coupled via the network 150.

FIG. 5A illustrates an example workflow 500A, depicting the interaction between the edge-side neural network model 232 and the cloud-side neural network model 292. In this workflow, the edge-side neural network model 232 is configured to generate early stage notification (e.g., by predicting failure) of the aircraft subsystems (e.g., including aircraft components) and systems.

In some cases, the edge-side neural network model 232 can selectively generate the early stage notification of the aircraft subsystems (e.g., including aircraft components). For example, the number of monitoring aircraft subsystems (e.g., including aircraft components) and systems can be scaled down based on the available computing resources onboard the aircraft, such that if the computing resources are limited, the edge-side neural network model 232 can be configured to select one or more of the components and systems to generate the early stage notification. Illustratively, the edge-side neural network model 232 may focus on short term mission-critical tasks, e.g., predicting early failures for components critical to the safe operation of the aircraft. For example, during flight, the edge- side neural network model 232 can monitor components directly linked to essential operations, such as the landing gear, which is responsible for safe takeoffs, landings, and taxiing. The landing gear system includes mechanical structures, hydraulic systems, and brakes, and it is monitored for hydraulic pressure, structural integrity, tire wear, and brake performance. Additionally, the edge-side neural network model 232 can monitor the aircraft's electronic systems, including navigation, communication, flight control, and instrumentation. These systems are assessed for signal quality, voltage stability, data transmission accuracy, and software reliability. Other monitored components may include hydraulic systems, which power critical functions like flight controls and brakes, and fuel systems, which ensure the delivery of fuel to the engines. These components are considered critical as their failure directly impacts the aircraft's ability to operate safely. The selection of components processed by the edge-side neural network model 232 can be predefined or dynamically configured by the operator (e.g., aircraft operator, administrator, and maintenance operator).

The workflow begins with process (1), where the edge-side neural network model 232 ingests sensor data from the internal sensor module 260. The internal sensor module 260 collects real-time data from one or more sensors installed on the aircraft. In the following, while different processes may be numbered, they do not necessarily imply a temporal sequence and can be performed simultaneously or in any technically suitable order.

In process (2), the ingested sensor data is transmitted to the cloud-side neural network model 292 for aggregation and further analysis.

In process (3), the edge-side neural network model 232 processes the ingested sensor data to generate early stage notification. In some examples, the edge-side neural network model 232 can generate early stage notifications of the aircraft subsystems (e.g., including aircraft components) in real-time using the edge-side neural network model 232. For example, the edge-side neural network model 232 can extract features from the sensor data using its hidden layers. For example, the first hidden layer identifies basic operational patterns, such as deviations in individual sensor readings, through weighted sums and activation functions. Subsequent hidden layers extract higher-order features by combining and refining earlier outputs, identifying localized patterns indicative of potential anomalies. In some examples, the extracted features of the sensor data can be compared with predefined criteria such that the extracted features are compared with the predefined criteria to determine whether the extracted features satisfy the predefined criteria. In this example, if the extracted features do not satisfy the predefined criteria, the notification can be generated. In some examples, the edge-side neural network model 232 generates notifications for critical components, and the number of monitored components depends on the computational resources available to the edge-side neural network model 232.

Processes (4) through (7) are performed by the cloud-side neural network model 292. While these processes are illustrated as occurring after process (3), they can be executed concurrently. In process (4), the cloud-side neural network module aggregates data transmitted from the edge-side neural network model 232. This includes sensor data, flagged anomalies, operational logs, and fleet-wide data aggregated from multiple aircraft connected to the cloud-side system.

In process (5), the cloud-side neural network model 292 performs state of health prediction for aircraft subsystems (e.g., including aircraft components) using the cloud- side neural network model 292. The cloud-side neural network model 292 processes the aggregated data by mapping individual data with a corresponding neuron included in hidden layers, where the cloud-side neural network model 292 can include tens, hundreds, or even millions of hidden layers, depending on the scale and complexity of the aggregated data. For instance, the neurons in the initial layers process the raw aggregated data, while deeper layers identify complex patterns and systemic issues, enabling detailed state of health predictions of the aircraft subsystems (e.g., including aircraft components) and systems.

In process (6), the cloud-side neural network model 292 detects or predicts failures in aircraft subsystems (e.g., including aircraft components) and generates the results. These predictions include components that may not have been flagged by the edge-side neural network model 232 due to resource constraints or limitations in its dataset.

In process (7), the cloud-side neural network module transmits the predicted failure results to the edge-side neural network module. If the cloud-side system detects patterns or failures not identified by the edge-side neural network model 232, it generates an updated set of coefficients for the edge-side neural network model 232. These updated coefficients enhance the edge-side model's predictive capabilities and enable it to monitor previously unrecognized failure patterns effectively. The detailed process of coefficient updating is illustrated in workflow SOOC, as shown in FIG. 5C.

FIG. 5B illustrates an example workflow SOOB that demonstrates the interaction between the edge-side neural network model 232 and the cloud-side neural network model 292. In this workflow, the edge-side neural network model 232 prioritizes aircraft subsystems (e.g., including aircraft components) for monitoring rather than performing comprehensive predictions of operational patterns and failures. To achieve this, the edge-side neural network model 232 utilizes a lightweight edge-side neural network model 232 with fewer hidden layers, enabling it to operate within the constrained computational resources available on the aircraft. For instance, the edge-side neural network model 232 monitors sensor data to determine if the measured parameters of each sensor are within predefined ranges, referred to as baseline ranges. Sensor data with parameters that deviate from these ranges are prioritized and flagged for further analysis.

The workflow begins with process (1), where the edge-side neural network model 232 ingests real-time sensor data from the internal sensor module 260. This module collects data from an array of sensors embedded across various systems and components of the aircraft. These sensors are designed to monitor critical aspects of the aircraft's operation, such as mechanical, hydraulic, thermal, and electrical parameters.

In process (2), the ingested sensor data is transmitted to the cloud-side neural network model 292, ensuring that all collected data is available for aggregation and fleet-wide analysis. This process establishes a foundation for further processing by the cloud- side system.

In process (3), the edge-side neural network model 232 analyzes the ingested sensor data to determine if the measured parameters of each sensor are within predefined baseline ranges. The edge-side neural network model 232, stored in the module, is configured to detect deviations from these ranges. For example, the model can include a single hidden layer where each neuron corresponds to an input sensor and compares its data against the associated baseline range. If any sensor data falls outside these predefined ranges, the model generates an output identifying these deviations. This prioritized data is then flagged for immediate transmission to the cloud-side neural network model 292 in process (4).

In process (5), the cloud-side neural network module aggregates the data transmitted by the edge-side neural network module. This aggregated data includes both the raw ingested data transmitted in process (2) and the prioritized sensor data transmitted in process (4). These processes can be performed simultaneously to ensure efficient data handling. The aggregated dataset may include operational logs, raw sensor readings, and prioritized data from multiple aircraft in the fleet, providing a comprehensive dataset for analysis.

In process (6), the cloud-side neural network model 292 processes the aggregated data using the cloud-side neural network model 292 to predict the life cycle and potential failures of aircraft subsystems (e.g., including aircraft components). The model's architecture is designed to handle extensive datasets and can include tens, hundreds, or even millions of hidden layers depending on the complexity of the data. The initial layers process raw aggregated data to identify broad trends and patterns, while intermediate layers detect more complex interactions, such as correlations between vibration anomalies and high-altitude operations. The deeper layers refine these patterns to produce detailed life cycle predictions and identify systemic issues across the fleet.

In process (7), the cloud-side neural network module transmits the prediction results back to the edge-side neural network model 232. These results may include insights specific to the prioritized sensor data flagged by the edge-side neural network model 232 and broader fleet-wide predictions derived from the aggregated dataset.

FIG. 5C illustrates an example workflow SOOC that expands upon the interaction between the edge-side neural network model 232 and the cloud-side neural network model 292. This workflow demonstrates how the edge-side neural network model 232, equipped with a pretrained edge-side neural network model 232, can either perform predictions of failures for specific aircraft subsystems (e.g., including aircraft components) or monitor their operational status. The workflow SOOC can function independently or integrate with workflows 500A and SOOB.

The workflow begins with process (1), where the edge-side neural network model 232 ingests real-time sensor data from the internal sensor module 260, similar to the initial process in workflow SOOB. In process (2), the ingested data is transmitted to the cloud- side neural network model 292 for aggregation and further analysis.

In process (3), the cloud-side neural network module aggregates the transmitted data, including operational logs, raw sensor readings, and other relevant datasets from the fleet of aircraft. This aggregated data forms the input for process (4), where the cloud- side neural network model 292 performs a fleet-wide analysis. The initial layers of the model process the aggregated data to identify common patterns, such as shared failure modes or trends linked to environmental conditions. Intermediate layers combine these findings with historical data to detect complex systemic interactions, while deeper layers refine these insights into detailed life cycle predictions for components across the fleet.

In process (5), the cloud-side neural network model 292 uses the aggregated data and the results of the fleet-wide analysis to generate updated coefficients for the edge-side neural network model 232. These coefficients are transmitted to the edge-side neural network model 232 in process (6), where they are integrated into the edge-side neural network model. This update ensures that the edge-side model remains aligned with the latest predictive insights and operational conditions, enhancing its accuracy and performance.

Unless the context clearly requires otherwise, throughout the description and the claims, the words "comprise," "comprising," "include," "including" and the like are to be construed in an inclusive sense, as opposed to an exclusive or exhaustive sense; that is to say, in the sense of "including, but not limited to." The word "coupled," as generally used herein, refers to two or more elements that may be either directly connected, or connected by way of one or more intermediate elements. Likewise, the word "connected," as generally used herein, refers to two or more elements that may be either directly connected, or connected by way of one or more intermediate elements. Additionally, the words "herein," "above," "below," and words of similar import, when used in this application, shall refer to this application as a whole and not to any particular portions of this application. Moreover, as used herein, when a first element is described as being "on" or "over" a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word "or" in reference to a list of two or more items, that word covers all of the following interpretations of the word: any of the items in the list, all of the items in the list, and any combination of the items in the list.

Moreover, conditional language used herein, such as, among others, "can," "could," "might," "may," "e.g.," "for example," "such as" and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are in any way required for one or more embodiments.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions, and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

1. A distributed neural network for aircraft monitoring, the neural network comprising:an edge-side neural network system for implementation in an aircraft comprising a local memory and a local processor, the edge-side neural network system comprising an edge-side neural network model to be stored on the local memory, and the local processor communicatively coupled with the local memory and adapted to execute the edge-side network model,wherein the edge-side neural network model is configured to:receive as input sensor data in real time from a plurality of sensors installed on the aircraft for sensing operational parameters of one or more subsystems of the aircraft,classify the sensor data to determine whether one or more of the sensor data satisfies a predetermined early stage notification criteria of the one or more subsystems,provide an early stage notification based on the classified sensor data, and provide the sensor data and the classified sensor data as an output to a cloud-side neural network system communicatively coupled with the edge-side neural network system; andthe cloud-side neural network system for implementation in a ground station,
the cloud-side neural network system comprising a cloud-side neural network model configured to:receive the output of the edge-side neural network model, determine a state of health of the aircraft including states of health of the one or more subsystems, andoutput updated parameters for the edge-side neural network model as further input to be transmitted to the edge-side neural network system.

2. The distributed neural network of claim 1, wherein the early stage notification criteria comprises an early stage failure criteria of the one or more subsystems, and wherein
the early stage notification comprises an early stage failure notification of the one or more subsystems.

3. The distributed neural network of claim 1, wherein the cloud-side neural network system is further configured to transmit the state of health of the aircraft, and wherein the edge-side neural network model is further configured to create an edge-side neural network model training set, the training set comprising at least one of: the state of health of the aircraft, the input sensor data, the classified sensor data, the predetermined early stage notification criteria, the early stage notification, current parameters of the edge-side neural network model, and the updated parameters of the edge-side neural network model.

4. The distributed neural network of claim 3, wherein the edge-side neural network system is configured for unsupervised training of the edge-side neural network model by using the edge-side neural network model training set.

5. The distributed neural network of claim 4, wherein the edge-side neural network model training set comprises the state of health of the aircraft, the input sensor data, the classified sensor data, the predetermined early stage notification criteria, the early stage notification, current parameters of the edge-side neural network model, and the updated parameters of the edge-side neural network model.

6. The distributed neural network of claim 1, wherein the cloud-side neural network model is configured to create a cloud-side neural network model training set, the cloud-side neural network model training set comprising at least one of: the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems.

7. The distributed neural network of claim 6, wherein the cloud-side neural network system is configured for unsupervised training of the cloud-side neural network model by using the cloud-side neural network model training set.

8. The distributed neural network of claim 7, wherein the cloud-side neural network model training set comprises the state of health of the aircraft, the input sensor data, the predetermined early stage notification criteria, the early stage notification, current parameters of the edge-side neural network model, and performance monitoring results of each
of the one or more subsystems of the aircraft based on performance criteria of the one or more subsystems.

9. The distributed neural network of claim 1, wherein the cloud-side neural network system is further configured to aggregate aircraft data by receiving outputs of edge- side neural networks implemented in other one or more aircraft and operational logs generated from the aircraft and the other one or more aircraft.

10. The distributed neural network of claim 9, wherein determining the state of health comprises predicting failure points of the one or more subsystems of the aircraft.

11. The distributed neural network of claim 10, wherein the cloud-side neural network model is configured to predict the failure points of the one or more subsystems of the aircraft by inferencing individual aircraft failure pattern from the aggregated aircraft data.

12. The distributed neural network of claim 10, wherein determining the state of health of the aircraft comprises:monitoring performance of each of the one or more subsystems of the aircraft based on performance criteria of the one or more subsystems,generating a reliability model of the one or more subsystems, and predicting performance degradation of the one or more subsystems based on monitoring results of the performance and the reliability model.

13. The distributed neural network of claim 10, wherein the cloud-side neural network system is configured to verify outputs of the edge-side neural network model with the predicted failure points of the one or more systems or components of the aircraft, and wherein cloud-side neural network system is configured to generate the updated parameters based on verification results.

14. The distributed neural network of claim 1, wherein the one or more subsystems of the aircraft comprise an engine propulsion system configured to generate power for the aircraft and an electronics system for navigation, communication, flight control and instrumentation of the aircraft.

15. The distributed neural network of claim 1, wherein the local processor comprises one or more local processors configured to perform workloads generated from the edge-side neural network model.

16. The distributed neural network of claim 1, wherein the ground station comprises one or more local processors adapted for accelerating neural network computations selected from one or more central processing units (CPUs), one or more tensor processing units (TPUs) , one or more graphical processing units (GPUs), and one or more neural processing units (NPUs).

17. The distributed neural network of claim 1, wherein the edge-side neural network model is a lightweight neural network model having less than half of an average number of neurons per hidden layer relative to an average number of neurons per hidden layer of the cloud-side neural network model.

18. he distributed neural network of claim 1, wherein the cloud-side neural network model comprises 10 to 100 times more hidden layers than the edge-side neural network model.

19. The distributed neural network of claim 1, wherein modeling the state of health of the aircraft is determined by categorizing the one or more systems or components of the aircraft into an electrical subsystem, a mechanical subsystem, and a thermal subsystem.

20. The distributed neural network of claim 1, wherein the aircraft and the ground station are communicatively coupled by using a combination of a satellite communication (SATCOM) that utilizes satellite communication channels for global coverage, a very high frequency (VHF) or high frequency (HF) radio systems that utilize a specific frequency band to facilitate communication over medium to long distances, and an air-to-ground (ATG) network that utilizes a high bandwidth channel over a shorter ranges.

21. A method for aircraft monitoring, the method comprising:receiving sensor data in real time from a plurality of sensors installed on an aircraft as an input to an edge-side neural network model stored in a local memory of an edge-side neural network system for implementation in an aircraft, each of the plurality of sensors configured to monitor operations of one or more subsystems of the aircraft;generating an early stage notification by executing the edge-side neural network model, using a local processor communicatively coupled with the local memory, to:
classify the sensor data to determine whether one or more of the sensor data satisfies a predetermined early stage notification criteria of one or more subsystems, and
determine the early stage notification based on the classified sensor data;
providing the sensor data, the classified sensor data, and the determined early stage notifications, as an output to a cloud-side neural network model included in a cloud-side neural network system for implementation in a ground station, the cloud- side neural network system communicatively coupled with the edge-side neural network system;
determining a state of health of the aircraft, including states of health of the one or more subsystems;
determining parameters for the edge-side neural network model based on the state of health of the aircraft and the generated early stage notification; and
updating parameters of the edge-side neural network model, by the edge-side neural network system, with the determined parameters transmitted from the cloud-side neural network system.

22. The method of claim 21, wherein the early stage notification criteria comprises an early stage failure criteria of the one or more subsystems, and wherein the early stage notification comprises an early stage failure notification of the one or more subsystems.

23. The method of claim 21, further comprising transmitting the state of health of the aircraft to the edge-side neural network system.

24. The method of claim 23 further comprising creating an edge-side neural network model training set by the edge-side neural network system, the edge-side neural network model training set comprising at least one of: the state of health of the aircraft, the input sensor data, the classified sensor data, the predetermined early stage notification criteria, the early stage notification, current parameters of the edge-side neural network model, and the updated parameters of the edge-side neural network model.

25. The method of claim 24, wherein the edge-side neural network system is configured for unsupervised training of the edge-side neural network model by using the edge- side neural network model training set.

26. The method of claim 25, wherein the edge-side neural network model training set comprises the state of health of the aircraft, the input sensor data, the classified sensor data, the predetermined early stage notification criteria, the early stage notification, current parameters of the edge-side neural network model, and the updated parameters of the edge- side neural network model.

27. The method of claim 21, further comprising creating a cloud-side neural network model training set by the cloud-side neural network system, the cloud-side neural network model training set comprising at least one of: the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems.

28. The method of claim 27, wherein the cloud-side neural network system is configured for unsupervised training of the cloud-side neural network model by using the cloud-side neural network model training set.

29. The method of claim 28, wherein the cloud-side neural network model training set comprises the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems.

30. The method of claim 21, wherein determining the state of health comprises predicting failure points of the one or more subsystems of the aircraft.

31. The method of claim 30, wherein determining the state of health further comprises:analyzing sensor data to identify periodic anomality pattern of the one or more subsystems, wherein the sensor data is a time-series data,categorizing the one or more subsystems into an electrical subsystem, a mechanical subsystem, and a thermal subsystem,extracting features from each subsystem, and monitoring aircraft performance related to the extracted features based on pre-defined optimal performance of the extracted features.

32. The method of claim 31, wherein the extracted features from the electrical subsystem comprises sensed voltages and currents of electrical components of the electrical subsystem, wherein the extracted features from the mechanical subsystem comprises wear patterns in structure components of the mechanical subsystem, and wherein the extracted features from the thermal subsystem comprises heat-dissipation patterns of heat-generating components of the thermal subsystem.

33. The method of claim 21, wherein the one or more subsystems of the aircraft comprise an engine propulsion system configured to generate power for the aircraft and an electronics system for navigation, communication, flight control and instrumentation of the aircraft.

34. The method of claim 21, wherein the cloud-side neural network system is further configured to aggregate aircraft data by receiving outputs of edge-side neural networks implemented in other one or more aircraft and operational logs generated from the aircraft and the other one or more aircraft.

35. The method of claim 34, wherein the cloud-side neural network model is configured to predict failure points of the one or more subsystems of the aircraft by inferencing individual aircraft failure pattern from the aggregated aircraft data.

36. The method of claim 35, wherein the cloud-side neural network system is configured to verify outputs of the edge-side neural network model with the predicted failure of the one or more systems or components of the aircraft, and wherein cloud-side neural network system is configured to generate the updated parameters based on verification results.

37. The method of claim 21, wherein the local processor comprises one or more local processors configured to perform workloads generated from the edge-side neural network model.

38. The method of claim 21, wherein the ground station comprises one or more local processors adapted for accelerating neural network computations selected from one or more central processing units (CPUs), one or more tensor processing units (TPUs) , and one or more neural processing units (NPUs).

39. The method of claim 21, wherein the edge-side neural network model is a lightweight neural network model having less than half of an average number of neurons per
hidden layer relative to an average number of neurons per hidden layer of the cloud-side neural network model.

40. The method of claim 39, wherein the cloud-side neural network model comprises 10 to 100 times more hidden layers than the edge-side neural network model.

41. A non-transitory computer readable medium storing instructions, when executed by one or more processors, causing the one or more processors to perform a method of:receiving sensor data in real time from a plurality of sensors installed on an aircraft as an input to an edge-side neural network model stored in a local memory of an edge-side neural network system for implementation in an aircraft;generating an early stage notification by executing the edge-side neural network model, using a local processor communicatively coupled with the local memory, to:classify the sensor data to determine whether one or more of the sensor data satisfies a predetermined early stage notification criteria of one or more subsystems, anddetermine an early stage notification based on the classified sensor data;providing the sensor data and the classified sensor data, as an output to a cloud- side neural network model included in a cloud-side neural network system for implementation in a ground station, the cloud-side neural network system communicatively coupled with the edge-side neural network system;receiving updated parameters for the edge-side neural network model from the cloud-side neural network system; andupdating parameters of the edge-side neural network model, by the edge-side neural network system, with the updated parameters.

42. The method of claim 41, wherein the early stage notification criteria comprises an early stage failure criteria of the one or more subsystems, and wherein the early stage notification comprises an early stage failure notification of the one or more subsystems.

43. The method of claim 41, further comprising receiving a state of health of the aircraft to the cloud-side neural network system, wherein the cloud-side neural network model is configured to:
determine the state of health of the aircraft, including states of health of the one or more subsystems; and
determine parameters for the edge-side neural network model based on the state of health of the aircraft and the generated early stage notification.

44. The method of claim 43 further comprising creating an edge-side neural network model training set by the edge-side neural network system, the edge-side neural network model training set comprising at least one of: the state of health of the aircraft, the input sensor data, the classified sensor data, the predetermined early stage notification criteria, the early stage notification, current parameters of the edge-side neural network model, and the updated parameters of the edge-side neural network model.

45. The method of claim 44, wherein the edge-side neural network system is configured for unsupervised training of the edge-side neural network model by using the edge- side neural network model training set.

46. The method of claim 45, wherein the edge-side neural network model training set comprises the state of health of the aircraft, the input sensor data, the classified sensor data, the predetermined early stage notification criteria, the early stage notification, current parameters of the edge-side neural network model, and the updated parameters of the edge- side neural network model.

47. The method of claim 43, further comprising creating a cloud-side neural network model training set by the cloud-side neural network system, the cloud-side neural network model training set comprising at least one of: the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems.

48. The method of claim 47, wherein the cloud-side neural network system is configured for unsupervised training of the cloud-side neural network model by using the cloud-side neural network model training set.

49. The method of claim 48, wherein the cloud-side neural network model training set comprises the state of health of the aircraft, the input sensor data, the predetermined early stage notification criteria, the early stage notification, current parameters of the edge-side
neural network model, and performance monitoring results of each of the one or more subsystems of the aircraft based on performance criteria of the one or more subsystems

50. The method of claim 41, wherein the cloud-side neural network system is configured to determine the updated parameters by:determining a state of health of the aircraft, including states of health of the one or more subsystems; anddetermining parameters for the edge-side neural network model based on the state of health of the aircraft and the generated early stage notification.

51. The method of claim 50, wherein determining the state of health comprises predicting failure points of the one or more subsystems of the aircraft.

52. The method of claim 51, wherein determining the state of health further comprises:analyzing sensor data to identify periodic anomality pattern of the one or more subsystems, wherein the sensor data is a time-series data,categorizing the one or more subsystems into an electrical subsystem, a mechanical subsystem, and a thermal subsystem,extracting features from each subsystem, and monitoring aircraft performance related to the extracted features based on pre-defined optimal performance of the extracted features.

53. The method of claim 52, wherein the extracted features from the electrical subsystem comprises sensed voltages and currents of electrical components of the electrical subsystem, wherein the extracted features from the mechanical subsystem comprises wear patterns in structure components of the mechanical subsystem, and wherein the extracted features from the thermal subsystem comprises heat-dissipation patterns of heat-generating components of the thermal subsystem.

54. The method of claim 41, wherein the one or more subsystems of the aircraft comprise an engine propulsion system configured to generate power for the aircraft and an electronics system for navigation, communication, flight control and instrumentation of the aircraft.

55. The method of claim 41, wherein the cloud-side neural network system is configured to aggregate aircraft data by receiving outputs of edge-side neural networks
implemented in other one or more aircraft and operational logs generated from the aircraft and the other one or more aircraft.

56. The method of claim 55, wherein the cloud-side neural network model is configured to predict failure points of the one or more subsystems of the aircraft by inferencing individual aircraft failure pattern from the aggregated aircraft data.

57. The method of claim 56, wherein the cloud-side neural network system is configured to verify outputs of the edge-side neural network model with the predicted failure of the one or more systems or components of the aircraft, and wherein cloud-side neural network system is configured to generate the updated parameters based on verification results.

58. The method of claim 41, wherein the local processor comprises one or more local processors configured to perform workloads generated from the edge-side neural network model.

59. The method of claim 41, wherein the ground station comprises one or more local processors adapted for accelerating neural network computations selected from one or more central processing units (CPUs), one or more tensor processing units (TPUs) , and one or more neural processing units (NPUs).

60. The method of claim 41, wherein the edge-side neural network model is a lightweight neural network model having less than half of an average number of neurons per hidden layer relative to an average number of neurons per hidden layer of the cloud-side neural network model.

61. The method of claim 60, wherein the cloud-side neural network model comprises 10 to 100 times more hidden layers than the edge-side neural network model.

62. An aircraft, comprising:an edge-side neural network system for implementation in an aircraft comprising a local memory and a local processor, the edge-side neural network system comprising an edge-side neural network model to be stored on the local memory, and the local processor communicatively coupled with the local memory and adapted to execute the edge-side network model,wherein the edge-side neural network model is configured to:
receive as input sensor data in real time from a plurality of sensors installed on the aircraft for sensing operational parameters of one or more subsystems of the aircraft,
classify the sensor data to determine whether one or more of the sensor data satisfies a predetermined early stage notification criteria of the one or more subsystems, and
provide an early stage notification based on the classified sensor data, and provide the sensor data and the classified sensor data, as an output to a cloud-side neural network model included in a cloud-side neural network system for implementation in a ground station, the cloud-side neural network system communicatively coupled with the edge-side neural network system;
receive updated parameters for the edge-side neural network model from the cloud-side neural network system;
receive state of health of the aircraft from the cloud-side neural network system; and
update parameters of the edge-side neural network model with the received parameters.

63. The aircraft of claim 62, wherein the early stage notification criteria comprises an early stage failure criteria of the one or more subsystems, and wherein the early stage notification comprises an early stage failure notification of the one or more subsystems.

64. The aircraft of claim 62, wherein the edge-side neural network model is further configured to create an edge-side neural network model training set, the training set comprising at least one of: the state of health of the aircraft, the input sensor data, the classified sensor data, the predetermined early stage notification criteria, the early stage notification, current parameters of the edge-side neural network model, and the updated parameters of the edge- side neural network model.

65. The aircraft of claim 64, wherein the edge-side neural network system is configured for unsupervised training of the edge-side neural network model by using the edge- side neural network model training set.

66. The aircraft of claim 65, wherein the edge-side neural network model training set comprises the state of health of the aircraft, the input sensor data, the classified sensor data, the predetermined early stage notification criteria, the early stage notification, current parameters of the edge-side neural network model, and the updated parameters of the edge- side neural network model.

67. The aircraft of claim 62, wherein the cloud-side neural network model is configured to create a cloud-side neural network model training set, the cloud-side neural network model training set comprising at least one of: the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems.

68. The aircraft of claim 67, wherein the cloud-side neural network system is configured for unsupervised training of the cloud-side neural network model by using the cloud-side neural network model training set.

69. The aircraft of claim 68, wherein the cloud-side neural network model training set comprises the state of health of the aircraft, the input sensor data, the predetermined early stage notification criteria, the early stage notification, current parameters of the edge-side neural network model, and performance monitoring results of each of the one or more subsystems of the aircraft based on performance criteria of the one or more subsystems.

70. The aircraft of claim 62, wherein the cloud-side neural network system is further configured to aggregate aircraft data by receiving outputs of edge-side neural networks implemented in other one or more aircraft and operational logs generated from the aircraft and the other one or more aircraft.

71. The aircraft of claim 70, wherein determining the state of health comprises predicting failure points of the one or more subsystems of the aircraft.

72. The aircraft of claim 71, wherein the cloud-side neural network model is configured to predict the failure points of the one or more subsystems of the aircraft by inferencing individual aircraft failure pattern from the aggregated aircraft data.

73. The aircraft of claim 71, wherein determining the state of health of the aircraft comprises:
monitoring performance of each of the one or more subsystems of the aircraft based on performance criteria of the one or more subsystems,
generating a reliability model of the one or more subsystems, and predicting performance degradation of the one or more subsystems based on monitoring results of the performance and the reliability model.

74. The aircraft of claim 73, wherein the cloud-side neural network system is configured to verify outputs of the edge-side neural network model with the predicted failure points of the one or more systems or components of the aircraft, and wherein cloud-side neural network system is configured to generate the updated parameters based on verification results.

75. The aircraft of claim 56, wherein the one or more subsystems of the aircraft comprise an engine propulsion system configured to generate power for the aircraft and an electronics system for navigation, communication, flight control and instrumentation of the aircraft.

76. The aircraft of claim 56, wherein the local processor comprises one or more local processors configured to perform workloads generated from the edge-side neural network model.

77. The aircraft of claim 56, wherein the ground station comprises one or more local processors adapted for accelerating neural network computations selected from one or more central processing units (CPUs), one or more tensor processing units (TPUs) , one or more graphical processing units (GPUs), and one or more neural processing units (NPUs).

78. The aircraft of claim 56, wherein the edge-side neural network model is a lightweight neural network model having less than half of an average number of neurons per hidden layer relative to an average number of neurons per hidden layer of the cloud-side neural network model.

79. The aircraft of claim 70, wherein the cloud-side neural network model comprises 10 to 100 times more hidden layers than the edge-side neural network model.

80. The aircraft of claim 62, wherein modeling the state of health of the aircraft is determined by categorizing the one or more systems or components of the aircraft into an electrical subsystem, a mechanical subsystem, and a thermal subsystem.

81. The aircraft of claim 62, wherein the aircraft and the ground station are communicatively coupled by using a combination of a satellite communication (SATCOM)
that utilizes satellite communication channels for global coverage, a very high frequency (VHF) or high frequency (HF) radio systems that utilize a specific frequency band to facilitate communication over medium to long distances, and an air-to-ground (ATG) network that utilizes a high bandwidth channel over a shorter ranges.
